(19) United States
(12) Patent Application Publication
(10) Pub. No.: US 2013/0008083 A1
(43) Pub. Date: Jan. 10, 2013

(54) TOMATO CAGE FORMED OF HOLLOW WIRE

(76) Inventors: Donald E. Weder, Highland, IL (US); Andrew Weder, Highland, IL (US)

(21) Appl. No.: 13/345,971

(22) Filed: Jan. 9, 2012

Related U.S. Application Data
(63) Continuation-in-part of application No. 11/881,164, filed on Jul. 26, 2007, now abandoned.
Application No. 11/881,164 is a division of application No. 11/823,429, filed on Jun. 27, 2007, now abandoned.
(60) Provisional application No. 60/816,745, filed on Jun. 27, 2006.

(51) Int. Cl. B65D 6/08; A01G 9/12

(52) U.S. Cl. 47/45; 220/485

(57) ABSTRACT

A tomato cage that is formed of a hollow wire is disclosed.

### CROSS-REFERENCE TO RELATED APPLICATIONS

This application is a continuation-in-part of U.S. Ser. No. 11/881,164, filed Jul. 26, 2007; which is a divisional of U.S. Ser. No. 11/823,429, filed Jun. 27, 2007, now abandoned; which claims benefit under 35 U.S.C. 119(e) of U.S. Ser. No. 60/816,745, filed Jun. 27, 2006. The entire contents of each of the above-referenced applications are hereby expressly incorporated herein by reference.

### BACKGROUND OF THE INVENTION

Wire is a commonly used mechanical aid in floral arranging and numerous other fields. In the floral industry, the most important uses for wire include supporting flower stems, such as in straightening a curved stem, curving a straight stem, or gathering and holding multiple stems together. While floral arrangers generally want to avoid any visible wires and other aids, for many florists the wiring of stems is considered a requirement for increasing customer satisfaction. Support wires can help prevent breakage of the flower heads during delivery and also assist flowers in receiving adequate water. Other important uses of support wires include their use in flower stem replacement, creating accessory stems in corsage and carried bouquet construction, joining stems into clusters for a single insertion, plus a wide array of other miscellaneous attachment and joining functions.

Florist wire is often treated (annealed) for improved flexibility and is often coated with an enamel (often green) to resist rusting and to blend with the floral stems and foliage. Florist wire is available from floral crafts stores in small quantities of 6″ or 12″ lengths, but florists usually obtain the 18″ length in 12 pound boxes, from which they can cut the other needed sizes. The important distinction among the wire strands is their size or gauge. Wire size is related by the gauge number: the smaller the wire diameter, the larger the gauge number. The general applications of the different wire sizes used by florists include, but are not limited to: heavy wire of #16-#18 gauge is used to support large stems or heavy flowers such as lilies, gladiolus, and snapdragons; medium weight wire of #20-#22 gauge is used to support stems of such flowers as roses, carnations, and chrysanthemums; light weight wire of #24-#26 gauge is used for replacing stems in corsages and bridal bouquets with flowers of average size, or to support smaller or lighter flower stems; very fine wire of #28-#30 gauge is used for delicate corsage flowers and for binding together stems with a heavier support wire; ultra fine wire of #32-#36 gauge is used for very delicate flowers and fine work in bridal arrangements, dainty corsages, and for glamellias.

The several methods of wiring replacement stems can be used in corsage construction. For general arranging work the emphasis is on stem support, with the selected method based on the character of the flower stem. In the majority of situations, the straight-wire (or wrapped wire) method will be used. Roses, carnations, and many other flowers with solid stems are usually wired in this way. One end of the wire is inserted into the base of the calyx (the stem enlargement just below the flower). The insertion needs to be only deep enough to keep the wire end from slipping out, as the rest of the wire is loosely wrapped in a spiral down the stem. With the wire of the appropriate gauge, it should be easy to flex the wire around the leaves, but one should avoid making too many turns around the stem with the wire. When completed, the wire should be reasonably straight for best wire strength and support. Some flowers, such as chrysanthemums, have a small, flat calyx which may not hold the wire end as desired. For these flowers, the hook-wire method can be more effective. In this method, the wire end is pushed from the calyx base through the flower face. A small hook is made in the wire end, and the wire is then pulled back to embed (and conceal) the wire in the flower face. The remaining wire is loosely wrapped about the stem as for the straight-wire method. A third technique, insertion wiring, works best with those flowers having fleshy or hollow stems, such as but not limited to, many of the spring bulb flowers. An outside wire wrap would only crush these stems. Instead, the wire is passed up through the hollow stem until it is imbedded in the calyx from the inside.

Some additional wire forms are also used in commercial and home floral arranging. When making wreaths or floral sprays, a continuous length of smaller gauge wire is needed for binding together the components as they are added. Paddle wire, either green-enameled or unpainted in #20-26 gauge, is readily available for this purpose. Some arrangers will also use products referred to as twist-ems or twist-ties, which comprises wire enclosed in a narrow paper cover. This product is available in continuous rolls to cut to the length needed. Another common support material is referred to as the chenille stem or pipe cleaner. This support material is actually composed of two wire strands that are twisted to hold threads, such as fuzzy colored threads, that make up the stem body. Most chenille stems are used in corsage work or in making accessories, but some other applications are possible when a colored joining wire may be desired.

An alternative joining material is floral tape or paraffin tape. This is a thin paper tape impregnated with paraffin. Such tape may be used instead of wire to secure a stem to a wood pick or to bind together a cluster of stems. It is also used as a wire wrap for extra rust resistance when the wire is in direct contact with water. It may also give a cushion along the wire to reduce possible damage to a delicate flower or stem. The tape typically comes in rolls of ½″ or 1″ width in a variety of colors. The main use of floral tape is in the construction of corsages, but there are opportunities for its benefit as a general floral arranging mechanical aid.

Floral ribbon wire may be used in corsage and carried flower arrangements, commercial designs and some home designs. Such arrangements and designs may include bows or various ribbon accessories as an important visible component or for other appropriate uses.

Wired ribbon (also referred to herein as “ribbon wire”) can be constructed by sandwiching wire between webs of satin (acetate) ribbon. The wired ribbon may have a solid color, or the wired ribbon may have printed patterns, lace or eyelet edges, or other decorative treatments. The finish on the two sides of the wired ribbon may be the same or different; for example, one side of the wired ribbon may be satin or shiny finish, while the other side may reveal a fabric weave and have a duller finish.

Flocked or velvet wired ribbon may be satin ribbons with a velvet-texture on one side. This added thickness makes them stiffer to aid in the production of bows, and the image of this added thickness is also especially popular for adding texture to holiday wreaths and other arrangements, as well as for use simply as bows or streamers alone. Cloth wired ribbon offers a wide variety of colors and patterns. These are usually one-sided colors or prints only, and the cloth does not offer the same crispness as satin ribbon for bow loops. Paper is also used as a wired ribbon material. These are made in a variety of solid colors and widths. The paper wired ribbon is loosely folded and twisted into a narrow coil, and it is unfolded as desired for use in a bow, wrap, or other decorative effect. This wrinkling in the paper adds to the informal image of the arrangement where this type of wired ribbon is appropriate. Wired ribbon allows dramatic images to be created, e.g., ribbon streamers can be softly bent to suggest that they are moving due to wind. While this does add to the ribbon cost, it also allows for a design impact that is not possible from the other types of wired ribbons. Other options that may fit the ribbon class of accessories include but are not limited to, curling ribbons, metallic cord, and solid or multi-colored yarn.

U.S. Pat. No. 5,293,713 discloses a hollow tubular device having a longitudinal opening. The hollow device can be used to enclose and surround a plant stem for supporting the stem in a floral arrangement. However, this tubular device cannot be used to wrap a floral stem, or inserted into a floral stem, or used in other aspects of floral construction or decoration in the same way floral wire can be used.

The present invention is directed to a novel type of hollow wire which retains the size, strength and usefulness of a solid wire while reducing the weight of the wire. Such hollow wire may be utilized in any desired floral packaging, including, but not limited to, floral stem support, paddle and spool wire.

### BRIEF DESCRIPTION OF THE DRAWINGS

FIG. 1 is a perspective view of a hollow wire constructed in accordance with the present invention.

FIG. 2 is a cross-sectional view of the hollow wire of FIG. 1 taken along line 2-2 thereof.

FIG. 3 is a perspective view of a hollow wire constructed in accordance with the present invention.

FIG. 4 is a cross-sectional view of the hollow wire of FIG. 3 taken along line 4-4 thereof.

FIG. 5 is a perspective view of a hollow wire constructed in accordance with the present invention.

FIG. 6 is a cross-sectional view of the hollow wire of FIG. 5 taken along line 6-6 thereof.

FIG. 7 is a perspective view of a hollow wire constructed in accordance with the present invention.

FIG. 8 is a cross-sectional view of the hollow wire of FIG. 7 taken along line 8-8 thereof.

FIG. 9 is a perspective view of a hollow wire constructed in accordance with the present invention.

FIG. 10 is a cross-section view of the hollow wire of FIG. 9 taken along line 10-10 thereof.

FIG. 11 is a perspective view of a hollow wire constructed in accordance with the present invention.

FIG. 12 is a cross-section view of the hollow wire of FIG. 11 taken along line 12-12 thereof.

FIG. 13 is a perspective view of a hollow wire constructed in accordance with the present invention.

FIG. 14 is a cross-section view of the hollow wire of FIG. 13 taken along line 14-14 thereof.

FIG. 15 is a perspective view of a hollow wire constructed in accordance with the present invention.

FIG. 16 is a cross-section view of the hollow wire of FIG. 15 taken along line 16-16 thereof.

FIG. 17 is a perspective view of a hollow wire constructed in accordance with the present invention.

FIG. 18 is a cross-section view of the hollow wire of FIG. 17 taken along line 18-18 thereof.

FIG. 19 is a perspective view of a coated hollow wire constructed in accordance with the present invention.

FIG. 20 is a cross-section view of the coated hollow wire of FIG. 19 taken along line 20-20 thereof.

FIG. 21 is a perspective view of a coated hollow wire constructed in accordance with the present invention.

FIG. 22 is a cross-section view of the coated hollow wire of FIG. 21 taken along line 22-22 thereof.

FIG. 23 is a perspective view of a hollow wired ribbon constructed in accordance with the present invention.

FIG. 24 is a cross-section view of the hollow wired ribbon of FIG. 23 taken along line 24-24 thereof.

FIG. 25 is a perspective view of a hollow wired ribbon constructed in accordance with the present invention.

FIG. 26 is a cross-section view of the hollow wired ribbon of FIG. 25 taken along line 26-26 thereof.

FIG. 27 is a perspective view of a hollow wire constructed in accordance with the present invention.

FIG. 28 is a perspective view of a flower stem having a hollow wire of the present invention attached thereto.

FIG. 29 is a perspective view of a flower stem having a hollow wire of the present invention attached thereto.

FIG. 30 is a perspective view of a flower stem having a hollow wire of the present invention attached thereto.

FIG. 31 is a perspective view of a flower stem having a hollow wire of the present invention attached thereto.

FIG. 32 is a perspective view of a flower stem having a hollow wire of the present invention attached thereto.

FIG. 33 is a perspective view of a flower stem having a hollow wire of the present invention attached thereto.

FIG. 34 is a perspective view of a floral grouping formed of a plurality of flowers wherein a hollow wire of the present invention is wrapped about stems of the flowers.

FIG. 35 is a perspective view of a corsage formed from a floral grouping and utilizing a hollow wire of the present invention in the construction of the corsage.

FIG. 36 is a top plan view of a wire mesh formed of a hollow wire of the present of invention.

FIG. 37 is a pictorial representation of a floral easel having a floral grouping connected to a support member formed of a hollow wire of the present invention.

FIG. 38 is a perspective view of a stone or casket plaque easel formed of a hollow wire of the present invention.

FIG. 39 is a pictorial representation of the stone or casket plaque easel of FIG. 38 supported on a casket and having a floral grouping mounted thereon.

FIG. 40 is a pictorial representation of the stone or casket plaque easel of FIG. 38 supported on a headstone and having a floral grouping mounted thereon.

FIG. 41 is a pictorial representation of a tomato cage 300.

FIG. 42 is a pictorial representation of another embodiment of a tomato cage, denoted herein by the general reference numeral 300a. The wire netting or mesh 270 shown in FIG. 36 may be employed in the construction of the tomato cage 300a.

### DETAILED DESCRIPTION OF THE INVENTION

Floral wire is an important tool in the modern floral industry and is used for constructing floral bouquets, floral arrangements, corsages and the like. The present invention contemplates a novel hollow floral wire and methods of use thereof in constructing items such as but not limited to, floral bouquets, floral arrangements, corsages and the like. The hollow wire contemplated herein may also be used in the hobby and craft industries as well as in the fields of detonation and construction, for example, for tying together materials such as steel or iron mesh or reinforcing rods and bars, or similar structures made of polymeric materials or wood materials.

The terms “flower”, “floral bouquet”, “floral arrangement”, “floral grouping”, “corsage” and other floral terms used herein will be understood to include at least one fresh, dried, or artificial floral material, or any combination thereof. Such terms are not limited to floral materials having both a bloom and stem end, but may include plant materials without a bloom end.

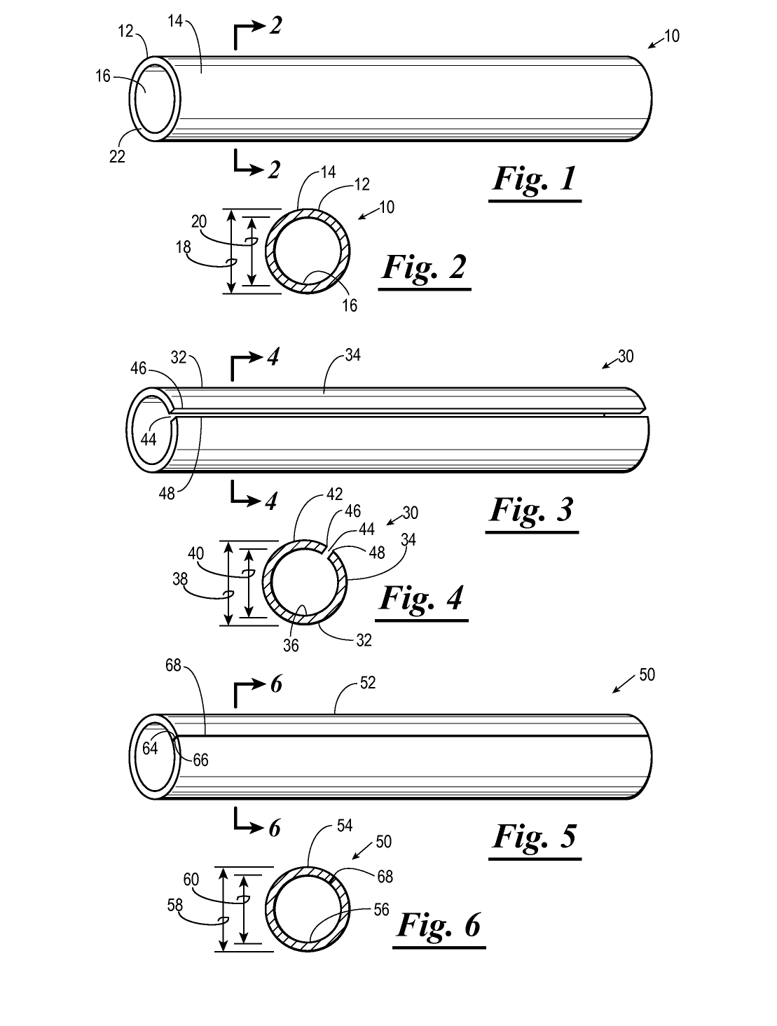

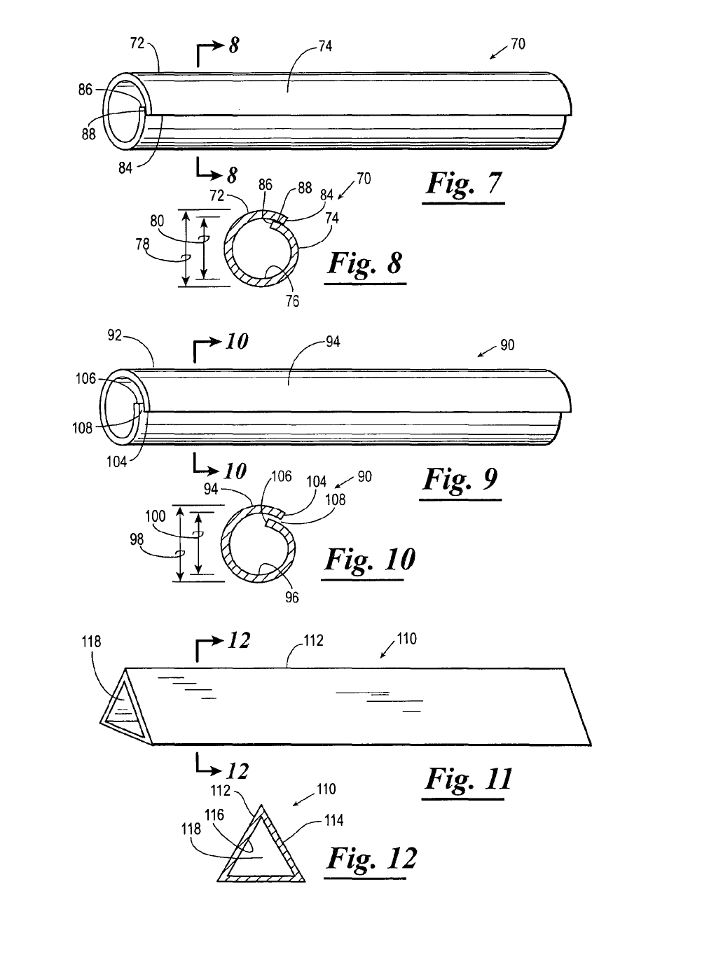

Referring now to the drawings and more particularly to FIGS. 1 and 2, shown therein and designated by the general reference numeral 10 is a hollow wire constructed in accordance with the present invention. The hollow wire 10 is provided with a sidewall 12 having an outer surface 14, an inner surface 16, an outer (external) diameter 18, and an inner (internal) diameter 20. The sidewall 12 of the hollow wire 10 is continuous and is thus closed along substantially its entire length except at the terminal ends. The gauge of the hollow wire 10 can vary widely and will depend to a large extent on the use of the hollow wire 10. The hollow wire 10 may be provided with any gauge of wire known in the art as desirable for use in the applications described herein. Generally, however, the gauge of the hollow wire 10 will range from 8 to 40, such as but not limited to, gauges 8, 10, 12, 14, 16, 18, 20, 22, 24, 26, 28, 30, 32, 34, 36, 38 and 40. The gauge of the hollow wire 10 is, however, not limited to these particular sizes.

The hollow wire of the present invention may be formed of any material that can function in accordance with the present invention as disclosed and required herein. For example but not by way of limitation, the hollow wire of the present invention may be constructed of steel, aluminum, other metals, metal alloys, polymers, paper, carbon fibers, carbon nanoparticles, carbon nanotube impregnated polymers, carbon nanotubes, combinations and derivatives thereof, and the like.

Shown in FIGS. 3 and 4 is another embodiment of hollow wire of the present invention, designated generally therein by the reference numeral 30. The hollow wire 30 is provided with a sidewall 32, having an outer surface 34, an inner surface 36, an outer (external) diameter 38 and an inner (internal) diameter 40. The hollow wire 30 is similar in construction to the hollow wire 10 of FIGS. 1 and 2, except that the sidewall 32 of hollow wire 30 is not continuous along its length and has a gap 44 formed between a first longitudinal edge 46 and a second longitudinal edge 48 of the sidewall 32. The gap 44 is illustrated as extending longitudinally, completely or substantially completely, along the length of the hollow wire 30. However, it is to be understood that the gap 44 may only extend longitudinally along only a portion of the length of the hollow wire 30, with the remainder of the length of the hollow wire 30 being substantially closed.

Shown in FIGS. 5 and 6 is another embodiment of hollow wire of the present invention, designated therein by the reference numeral 50. The hollow wire 50 is provided with a sidewall 52 having an outer surface 54, an inner surface 56, an outer (external) diameter 58 and an inner (internal) diameter 60. The hollow wire 50 is similar in construction to the hollow wire 30 of FIGS. 3 and 4, except that the sidewall 52 of the hollow wire 50 has a first longitudinal edge 64 and a second longitudinal edge 66 which extend longitudinally along the length of the hollow wire 50 and abut one another to form an abutting portion 68.

The abutting portion 68 may be attached or connected together by a bonding material or other methods known in the art; optionally, the abutting portion 68 may not be connected, and the shape of the hollow wire 50 may be maintained via the structural characteristics of the material from which the hollow wire 50 is formed. In addition, the abutting portion 68 is illustrated as extending longitudinally, completely or substantially completely, along the length of the hollow wire 50. However, it is to be understood that the abutting portion 68 may only extend longitudinally along only a portion of the length of the hollow wire 50, with the remainder of the length of the hollow wire 50 being open and/or the first and second longitudinal edges 64 and 66 being overlapped.

Shown in FIGS. 7 and 8 is another embodiment of hollow wire of the present invention, designated generally therein by the reference numeral 70. The hollow wire 70 is provided with a sidewall 72 having an outer surface 74, an inner surface 76, an outer (external) diameter 78 and an inner (internal) diameter 80. The hollow wire 70 is similar in construction to the hollow wire 50 of FIGS. 5 and 6, except that the sidewall 72 of the hollow wire 70 has a first longitudinal edge 84 and a second longitudinal edge 86 which extend longitudinally along the length of the hollow wire 70 and overlap to form an overlapping portion 88.

The overlapping portion 88 may be attached or connected together by a bonding material or other methods known in the art; optionally, the overlapping portion 88 may not be connected, and the shape of the hollow wire 70 may be maintained via the structural characteristics of the material from which the hollow wire 70 is formed. In addition, the overlapping portion 88 is illustrated as extending longitudinally, completely or substantially completely, along the length of the hollow wire 70. However, it is to be understood that the overlapping portion 88 may only extend longitudinally along only a portion of the length of the hollow wire 70, with the remainder of the length of the hollow wire 70 being open and/or the first and second longitudinal edges 84 and 86 abutting one another.

Shown in FIGS. 9 and 10 is another embodiment of hollow wire of the present invention, designated generally therein by the reference numeral 90. The hollow wire 90 is provided with a sidewall 92 having an outer surface 94, an inner surface 96, an outer (external) diameter 98 and an inner (internal) diameter 100. The hollow wire 90 is similar in construction to the hollow wire 70 hereinbefore described with reference to FIGS. 7 and 8, except that the hollow wire 90 has a first longitudinal edge 104 and a second longitudinal edge 106 which are spatially disposed and overlap, thus forming a gap 108 which extends along the length of the hollow wire 90 substantially as shown.

While the gap 108 is illustrated as extending longitudinally, completely or substantially completely, along the length of the hollow wire 90, it is to be understood that the gap 108 may only extend longitudinally along only a portion of the length of the hollow wire 90, with the remainder of the length of the hollow wire 90 being open and/or the first and second longitudinal edges 104 and 106 being overlapped and/or abutted against one another.

While FIGS. 3-10 illustrate hollow wires with either a gap 44, an abutting portion 68, an overlapping portion 88, or an overlapping portion with a gap 108, extending along substantially the entire length thereof, it is to be understood that a single length of hollow wire may be provided with a combination of two or more of the above, each extending separately along a portion of the length thereof. That is, the first and second longitudinal edges of a sidewall of a hollow wire may abut one another along a portion of the length of the hollow wire, may have a gap between one another along another portion of the length thereof, may overlap along another portion of the length of the hollow wire, and/or then may overlap but be spatially disposed from one another to provide a gap there between along yet another portion of the length of the hollow wire. It is to be understood that the hollow wire of the present invention may be provided with any number and combination of structures disclosed herein along a single length thereof.

While FIGS. 1-10 are illustrated as having a substantially circular cross-section, it is to be understood that the hollow wire of the present invention is not limited to such structures. Rather, any desired cross-sectional structure known in the art for wire or hollow devices or otherwise contemplated for use by a person having ordinary skill in the art, given this disclosure, may be utilized in accordance with the present invention. For example but not by way of limitation, FIGS. 11-14 specifically illustrate two other cross-sectional configurations that may be used in accordance with the present invention.

FIGS. 11 and 12 illustrate a hollow wire 110 provided with a sidewall 112 having an outer surface 114, an inner surface 116 and an inner space 118. The hollow wire 110 is provided with a substantially triangular cross-sectional configuration.

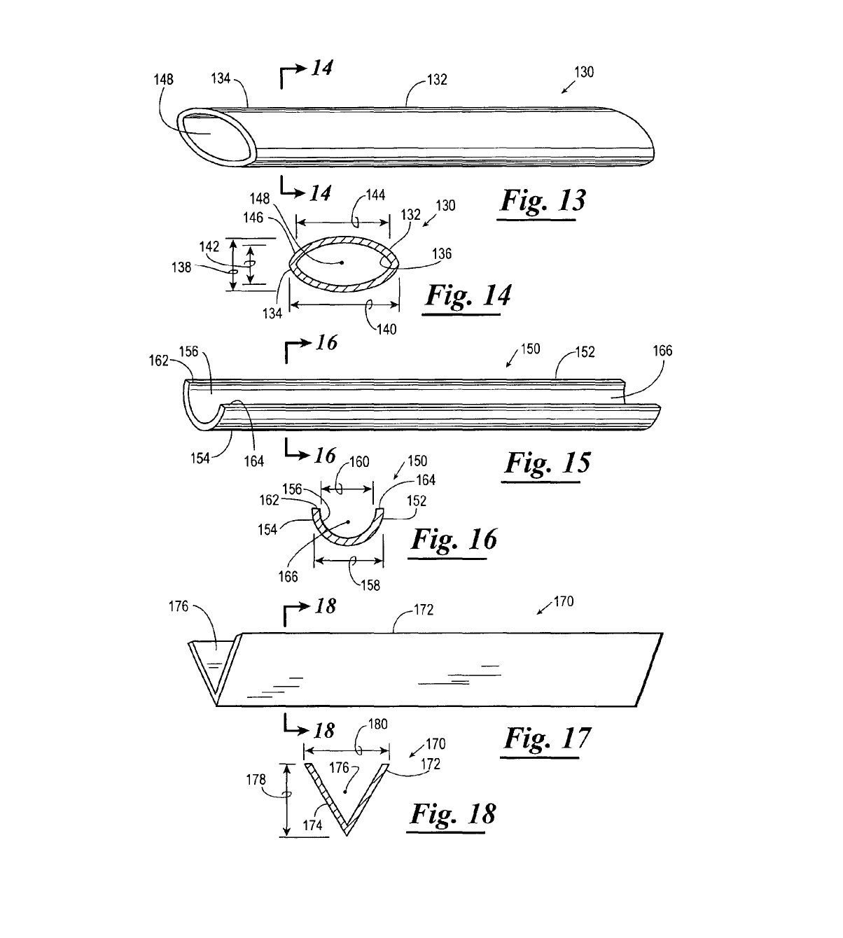

FIGS. 13 and 14 illustrate a hollow wire 130 provided with a sidewall 132 having an oval, elliptical or partially flattened cross-sectional configuration. The sidewall 132 of the hollow wire 130 has an outer surface 134 and an inner surface 136. The sidewall 132 has a first outer (external) diameter 138 in a substantially vertical direction and a second outer diameter 140 in a substantially horizontal direction. The sidewall 132 also has a first inner (internal) diameter 142 in a substantially vertical direction and a second inner diameter 144 in a substantially horizontal direction. The hollow wire 130 has an inner space 148.

While specific cross-sectional configurations are shown herein for various embodiments of the hollow wire described herein, it is to be understood that the hollow wire may have any desired cross-sectional configuration known in the art, including but not limited to, circular, oval, elliptical, parabolic, open curve, closed curve, square, rectangular, pentagonal, hexagonal, octagonal, trapezoidal, or any other polygonal cross-sections known in the art.

While the embodiments of hollow wire described herein above are provided with a substantially tubular structure, it is to be understood that the hollow wire of the present invention is not limited to substantially closed, tubular structures. Instead, the hollow wire of the present invention also includes open cross-sectional structures that function in accordance with the present invention. FIGS. 15-18 and their accompanying description describe two particular embodiments of such open cross-sectional structures of hollow wire; however, it is to be understood that the present invention is not limited to the particular open structures shown therein, but rather any open cross-sectional structure that can function as hollow wire in the applications described herein also falls within the scope of the present invention.

FIGS. 15 and 16 illustrate one such embodiment of hollow wire having an open cross-sectional structure in accordance with the present invention, the hollow wire being designated generally therein by the reference numeral 150. The hollow wire 150 is provided with a sidewall 152 having an outer surface 154 and an inner surface 156, an outer (external) diameter 158, an inner (internal) diameter 160, a first longitudinal edge 162 and a second longitudinal edge 164. The hollow wire 150 is similar in construction to the hollow wire 10 hereinbefore described with reference to FIGS. 1 and 2, except that the hollow wire 150 is provided with a substantially half-circular cross-sectional configuration rather than the circular cross-sectional configuration of the hollow wire 10. That is, the first and second longitudinal edges 162 and 164 of the hollow wire 150 do not connect but rather are disposed substantially parallel to one another such that the hollow wire 150 is provided with a substantially semi-circular or trough-shaped cross-sectional configuration that provides an inner space 166.

FIGS. 17 and 18 illustrate another embodiment of hollow wire having an open cross-sectional structure of the present invention, the hollow wire being designated generally therein by the reference numeral 170. The hollow wire 170 is provided with a first leg portion 172 and a second leg portion 174. The second leg portion 174 extends angularly from the first leg portion 172 so as to provide the hollow wire 170 with a substantially V-shaped cross-sectional configuration substantially as shown in FIG. 18. Thus, the first and second legs 172 and 174 cooperate to define a trough 176 extending along the length of the hollow wire 170. Further, the first and second legs 172 and 174 cooperate to provide the hollow wire 170 with a height 178 and a width 180 at an upper end of the trough 176 of the hollow wire 170. The trough 176 thus defines an inner space of the hollow wire 170.

While the troughs of the hollow wires of FIGS. 15-18 have been depicted as being substantially linear as they extend longitudinally from one end of the hollow wire to the opposite end, it is to be understood that the troughs may extend in any non-linear form longitudinally, such as for example, but not by way of limitation, in a spiral configuration longitudinally.

For FIGS. 15-18, a flower stem may be disposed and held in place thereabout with or without requiring that the flower stem be affixed to the hollow wire 150 or 170. For example, a bonding material may be required to maintain the hollow wire 150 or 170 in a position about the flower stem; alternatively, the hollow wire 150 or 170 could be wrapped spirally about the flower stem and thus maintained in a position about the flower stem without requiring the use of a bonding material.

The term “bonding material” as used herein, means any type of material or thing which can be used to effect the bonding or connecting of two materials or portions of the same material. Examples of bonding materials used in accordance with the present invention include, but are not limited to, adhesives, pressure sensitive adhesives, cohesives, heat sealable materials such as heat sealable lacquers and hot melt materials, sonic sealable and vibratory sealable materials, ties, labels, bands, ribbons, strings, tapes (including single or double-sided adhesive tapes), staples and combinations thereof.

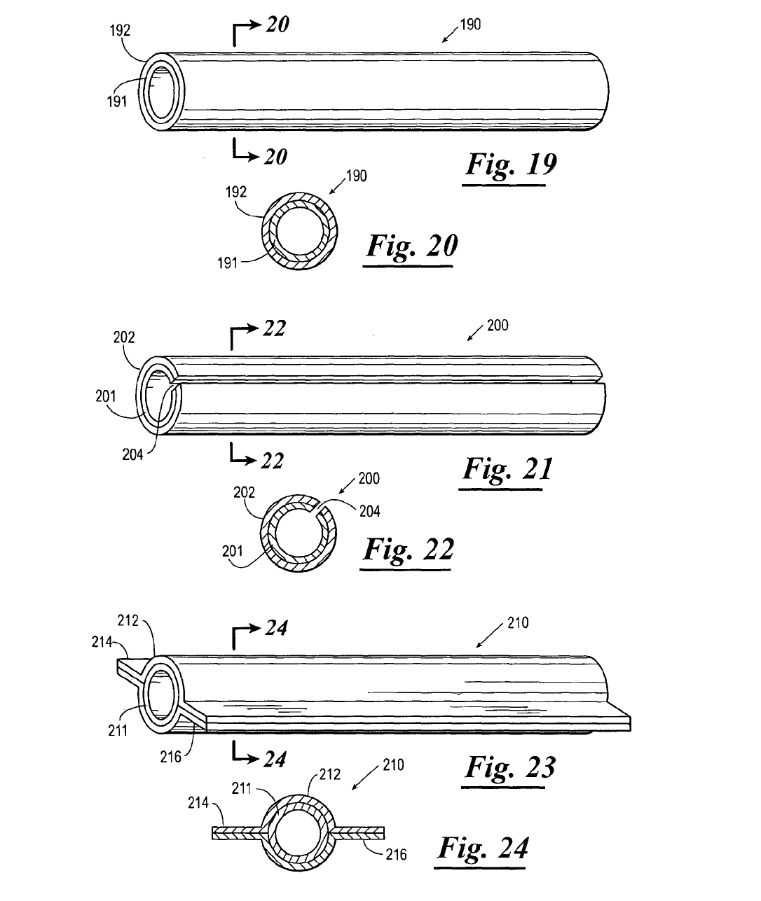

In yet another embodiment of the present invention, any of the hollow wires described herein previously may be provided with an outer coating disposed on at least a portion thereof. FIGS. 19-26 illustrate outer coatings disposed on exemplary hollow wire cores, and also illustrate different types and configurations of such outer coatings, as described in greater detail herein below.

FIGS. 19 and 20 illustrate a hollow wire 190 that includes a hollow core 191 and an outer coating 192. The hollow wire 191 may be similar in construction to any of the hollow wires described herein, such as but not limited to the hollow wire 10 of FIGS. 1 and 2. The outer coating 192 may be constructed of any suitable material known in the art for coating wire. For example but not by way of limitation, the outer coating 192 may be constructed of paper, plastic, ribbon material, rubber, polymeric material, fabric, enamel, paint, metal, metallized fabric, metallized polymeric film, ceramic material, flocking, bonding material, combinations thereof, or any other material known by a person of ordinary skill in the art for covering a wire.

It should be noted that any of the hollow wires described herein may be completely or partially covered with an outer coating, such as the outer coating 192, along at least a portion of a length thereof. For example, shown in FIGS. 21 and 22 is a hollow wire 200 having a hollow core 201 and an outer coating 202. The hollow core 201 is similar in construction to the hollow wire 30 hereinbefore described with reference to FIGS. 3 and 4. That is, the hollow core 201 is provided with a gap 204 which extends longitudinally along the length of the hollow core 201. The outer coating 202, which is constructed of material similar to those of the outer coating 192 of the hollow wire 190, does not extend completely over a gap 204 of the hollow core 201. However, it should be understood that the outer coating 202 could be modified to coat and cover the gap 204 of hollow core 201 if desired.

It is to be understood that any of the hollow wires described herein previously may be provided with an outer coating on at least a portion thereof, as described in relation to FIGS. 19-22 or as otherwise described herein or known in the art. Thus, such coated hollow wires (or partially coated hollow wires also fall within the scope of the present invention.

Another embodiment of hollow wire of the present invention is shown in FIGS. 23 and 24 and is designated therein by the general reference numeral 210. The hollow wire 210 is provided with a hollow core 211 and an outer coating 212. The hollow core 211 may be similar in construction to any of the hollow wires 10, 30, 50, 70, 90, 110 and 130 hereinbefore described with reference to FIGS. 1-14, or any other hollow wire described herein. However, the outer coating 212 defines a pair of oppositely disposed wings 214 and 216 substantially as shown. Thus, the hollow wire 210 can be used as a “ribbon wire” as known to persons of ordinary skill in the art. For example but not by way of limitation, the outer layer 212 may be formed of one or more layers of paper, plastic, rubber, fabric, ribbon material, polymeric material, metal, ceramic, paint, combinations thereof, or any other such material known for the purpose of covering a wire by persons of ordinary skill in the art.

It is to be understood that while the hollow wire 210 is illustrated as having the pair of oppositely disposed wings 214 and 216, the present invention is not limited to the hollow wire 210 having two wings. For example, the hollow wire 210 may be constructed with a single wing. This embodiment of the present invention would result in the hollow core 211 being disposed on an outer edge of the hollow wire 210, rather than being disposed in the center 210 of the hollow wire 210, as shown in FIGS. 23-24. In such embodiment, the outer coating 212 may extend around the hollow core 211 and therefore fully cover the hollow core 211, or a portion of the hollow core 211 may extend beyond the outer coating 212 and thus be exposed.

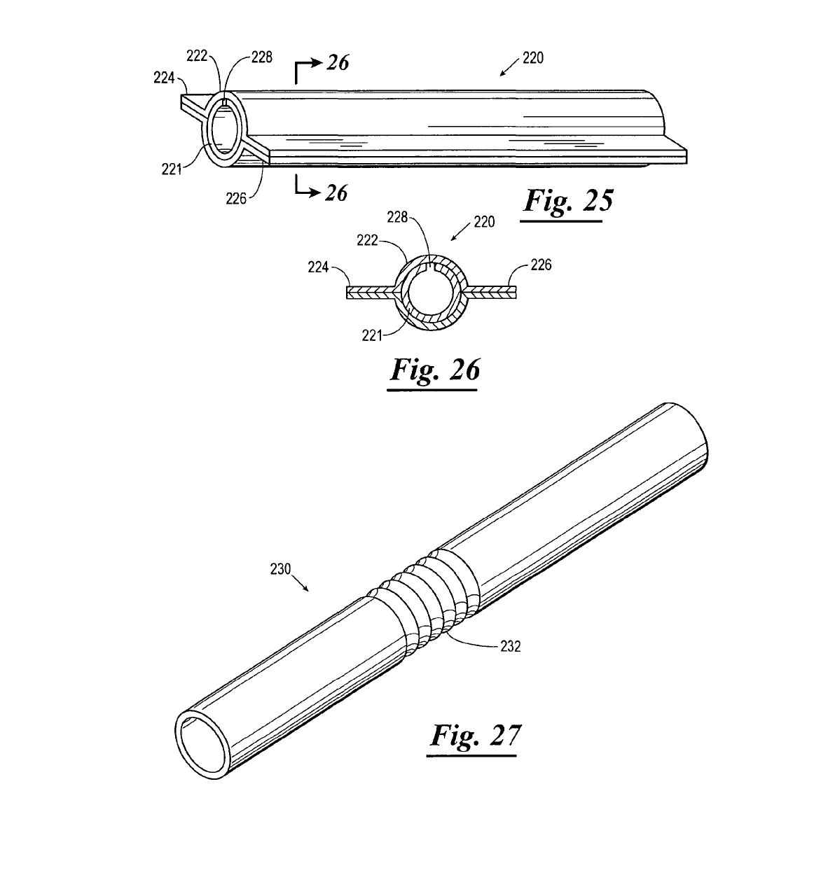

Any of the hollow wires described herein may be used in the manner of the hollow wire 210 as shown in FIGS. 23 and 24 or as described elsewhere herein. For example, as shown in FIGS. 25 and 26, a hollow wire 220 includes a hollow core 221 covered by an outer layer 222 having a pair of oppositely wings 224 and 226 substantially as shown. The hollow core 221 is provided with a longitudinally extending gap 228 and is similar in construction to the hollow wire 30 hereinbefore described with reference to FIGS. 3 and 4.

Shown in FIG. 27 is yet another embodiment of hollow wire in accordance with the present invention that is designated therein by the reference numeral 230. The hollow wire 230 is similar in construction to the hollow wire 10 hereinbefore described with reference to FIGS. 1 and 2, except that the hollow wire 230 has one or more corrugated or scored portions 232 to facilitate bending of the hollow wire 230. The corrugated or scored portions 232 may be disposed along only a portion of the length of the hollow wire 230, substantially as shown in FIG. 27, or the corrugated or scored portions 232 may extend substantially along the entire length of the hollow wire 230. Any of the hollow wires described hereinbefore may be provided with corrugated or scored portions in a similar manner.

In addition, any of the hollow wires described herein may be provided with at least one interlocking portion that functions to maintain the hollow wire in a bent position. The interlocking portions may be utilized with the corrugated or scored portions 232 as known in the art. In one embodiment, the interlocking portion may be a hook-like extension that engages a groove or triangular crease on another portion of the hollow wire. However, other examples of interlocking portions are known in the art, and therefore the above-described example of an interlocking portion is not to be considered limiting.

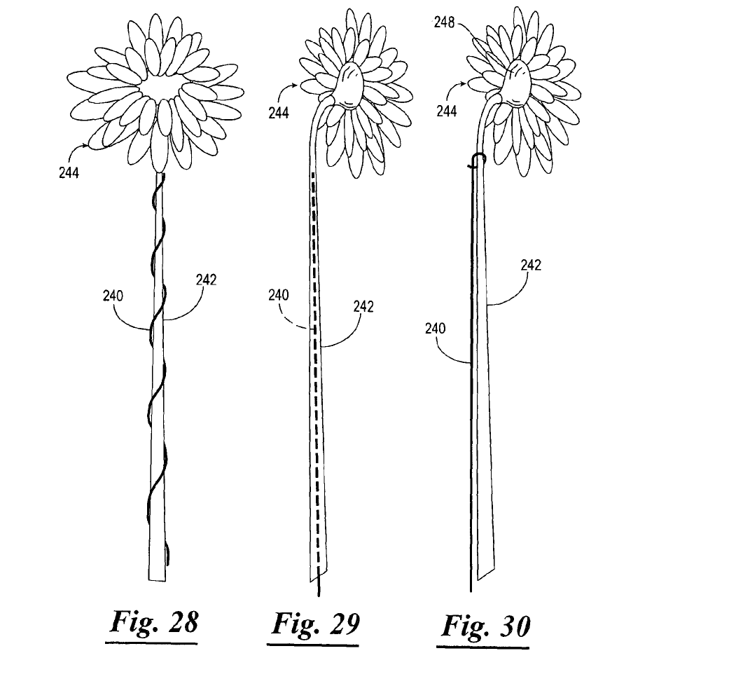

Any of the embodiments of hollow wire of the present invention can be used in a variety of manners, including but not limited to, any uses for which floral wire is acceptable, including but not limited to, floral arranging, craft or hobby uses, home decor uses, and other various decorative uses. For example, FIGS. 28-33 demonstrate five uses of a hollow wire 240 (which may be any of the hollow wires hereinbefore described) in supporting a single plant stem 242 of a flower or plant 244. In FIG. 28, the hollow wire 240 is wrapped about the plant stem 242 by methods known in the art for wrapping floral wire about a plant stem. In FIG. 29, the hollow wire 240 is inserted into the plant stem 242 of the flower or plant 244 by methods known in the art for inserting floral wire into a plant stem. In FIG. 30, the hollow wire 240 is extended along the plant stem 242 of the flower or plant 244 and provides support at an upper portion thereof, wherein the hollow wire 240 is hooked about or through a portion of the plant stem 245.

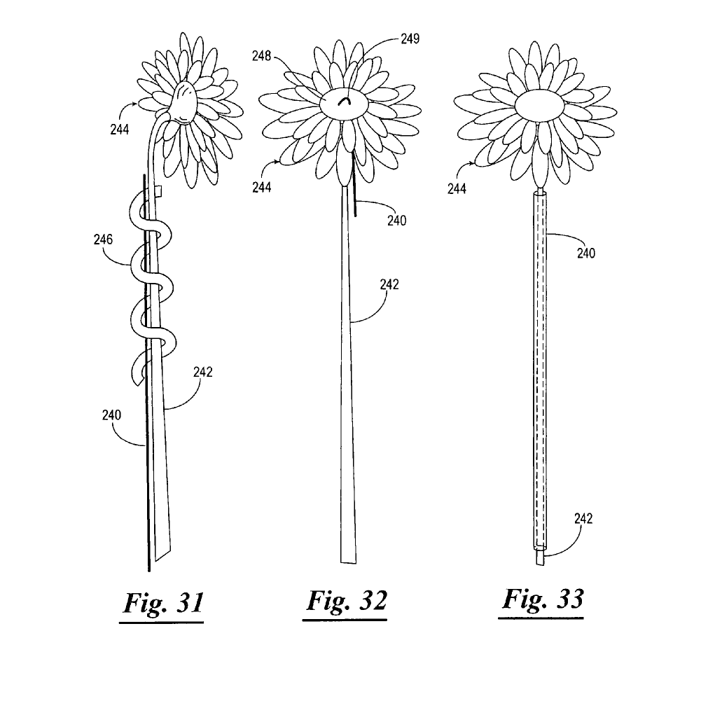

In FIG. 31, the hollow wire 240 is disposed substantially parallel to and substantially adjacent at least a portion of the plant stem 242 of the flower or plant 244. Rather than wrapping the hollow wire 240 about the plant stem 242, the hollow wire 240 and the plant stem 242 are simply placed side-by-side, and floral tape 246 is then wrapped about at least a portion thereof to hold the hollow wire 240 in position about the plant stem 242 and provide support thereto. In FIG. 32, the hollow wire 240 is inserted into the plant stem 242 or a portion of a flower head 248 (such as a calyx of the flower head 248) of the flower or plant 244 and extends up into the flower head 248 of the flower or plant 244. A hook 249 is then formed in the end of the hollow wire 240 extending through the flower head 248, and the hollow wire 240 is then pulled back down through the flower 242 until the hook is firmly embedded in the flower head 248. The portion of the hollow wire 240 disposed adjacent the plant stem 242 may then be wrapped thereabout, as described in relation to FIG. 28, or taped thereabout, as described in relation to FIG. 31.

In another method, the hollow wire 240 may be inserted as described for FIG. 32, except that the hollow wire 240 does not extend through the flower head 248. That is, the hollow wire 240 is inserted into the plant stem 242 or a portion of the flower head 248 without extending above the top of the flower head 248 to form the loop 249; in this fashion, an upper end of the hollow wire 240 is not visible in the manner shown in FIG. 32.

In FIG. 33, at least a portion of the plant stem 242 of the flower or plant 244 is inserted into the hollow wire 240.

Any of the techniques described herein with reference to FIGS. 28-33, as well as any other methods described herein or known in the art, may be utilized to lengthen the stem of a flower in addition to providing support thereto. This lengthening is accomplished by simply having the hollow wire extend beyond the plant stem.

Once the hollow wire 240 is disposed about or through the plant stem 242 by any of the methods shown in FIGS. 28-33 or otherwise known in the art, the plant stem 242 and hollow wire 240 may be wrapped with floral tape is desired, and can then be inserted together into a floral foam or other floral support material for supporting the plant. Alternatively, a number of flowers and/or plants can be combined to form a floral grouping. When combined to form the floral grouping, only one or only a portion of the floral grouping may have hollow wire disposed thereabout to support the individual flowers and/or plants.

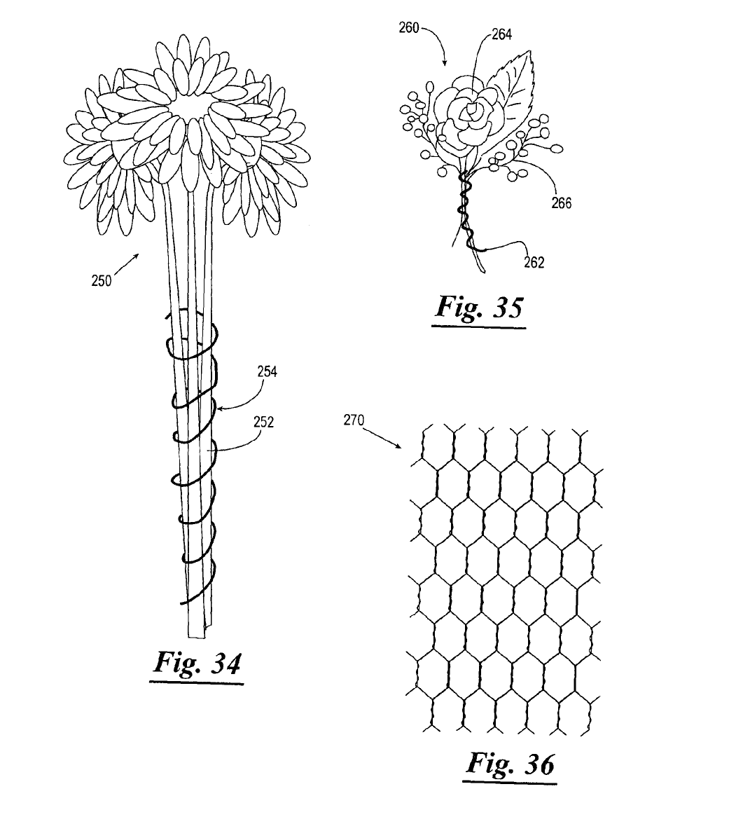

Optionally, rather than disposing hollow wire about one or more individual flowers and/or plants that are then utilized in producing a floral grouping, a plurality of flowers and/or plants may be first combined to form the floral grouping, and then at least one piece of hollow wire disposed about the floral grouping. For example, FIG. 34 depicts a floral grouping 250 comprising a grouping of flowers, each having a plant stem 252. The flowers are bunched together such that the plurality of plants stems 252 are brought into close proximity to one another, and then at least one hollow wire 254 (which may be any of the hollow wires herein before described) is wrapped about the plurality of plant stems 252 to secure the floral grouping.

Any of the methods described herein may include the step of taping at least a portion of wired flower(s) and/or plant(s) with floral tape. Taping serves several purposes, including but not limited to, holding moisture into the stem of a flower or plant, concealing the hollow wire, and ensuring that the flower/plant does not slip out of a wired mount.

FIG. 35 depicts a corsage 260 produced using a hollow wire 262 of the present invention. The hollow wire 262 may be any of the hollow wires described herein. The corsage 260 comprises at least one flower 264, and may further comprise at least one filler material 266. Examples of filler materials utilized in the art of corsage making include, but are not limited to, babies breath, leaves, ribbons, bows, and combinations thereof. The flower 264 and the at least one filler material 266 are placed together such that at least a portion of their stems are substantially adjacent and parallel. Then the hollow wire 262 is wrapped about at least a portion thereof by any of the methods described herein or known in the art. The stems with hollow wire 262 disposed thereabout may further be wrapped with floral tape, if desired.

The hollow wire of the present invention may also be used to construct various wire forms that are utilized in various floral and craft embodiments. FIG. 36 is a top plan view of a wire netting or mesh 270 which may be employed in the construction of various types of floral arrangements, such as corsages, floral wreaths, and the like. Any of the hollow wires hereinbefore described can be employed in the construction of the wire netting or mesh 270; and the wire netting or mesh 270 can be formed using conventional procedures well known in the art. In addition, the wire netting or mesh 270 may be used in a substantially flattened form as shown in FIG. 36, or the wire netting or mesh 270 may be shaped into any desired floral or craft form known in the art. Other types of floral or craft wire forms are known in the art, and the use of hollow wire in the construction of the same also falls within the scope of the present invention. In addition, the wire netting or mesh 270 formed of the hollow wire of the present invention may also be utilized in the formation of fencing or caging materials, such as but not limited to, animal or poultry-type fencing, tomato caging, and the like.

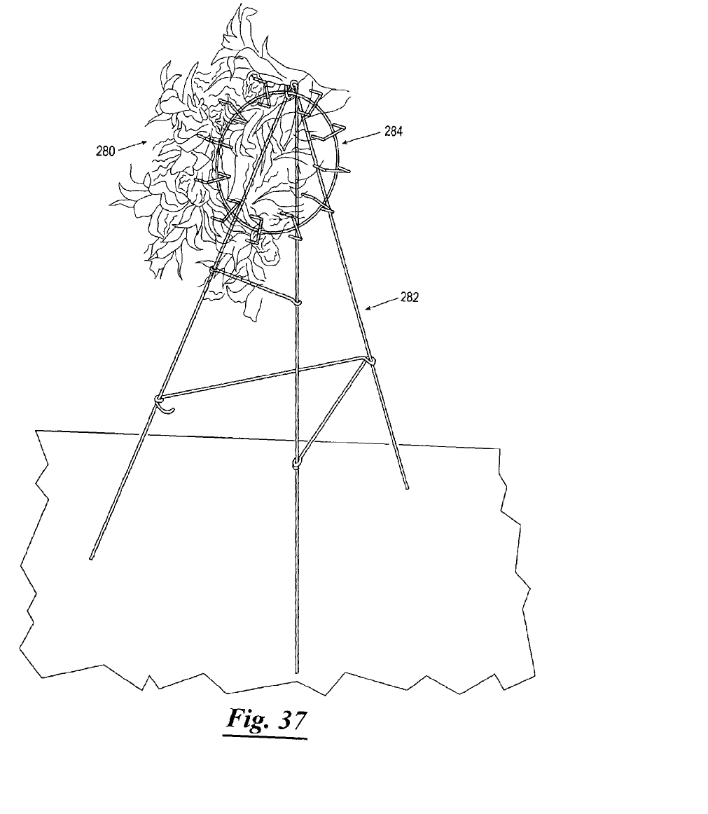

Referring now to FIG. 37, shown therein is a pictorial representation of a wreath 280 supported on an easel 282 via a support member 284. The support member 284 may assume any floral wire form known in the art, and can be fabricated using any of the hollow wire hereinbefore describe; therefore, the particular form of the support member 284 shown in FIG. 37 is for the purposes of illustration only. The support member 284 is of conventional construction, as is the construction of the wreath 280 and its attachment to the support member 284. Thus, no further comments concerning the construction of the support member 284 or its connection to the wreath 280 or the easel 282 is believed necessary in order to enable those skilled in the art to construct and use the support member 284 constructed of the hollow wires of the present invention.

In addition, at least a portion of the floral easel 282 of FIG. 37 may also be formed of a hollow wire in accordance with the present invention.

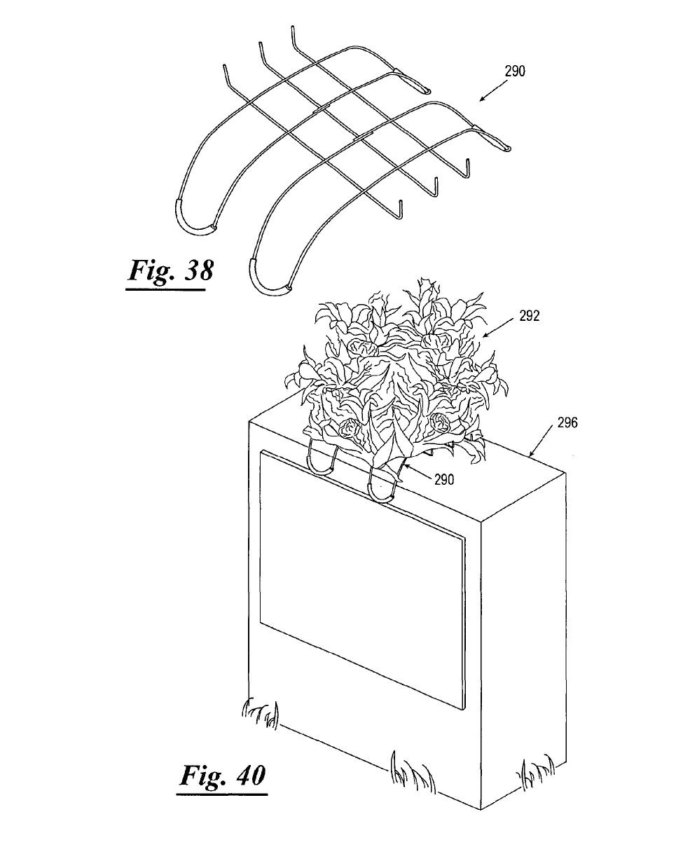

Referring now to FIGS. 38-40, shown therein is a floral easel or plaque 290 for use with a headstone, monument stone and/or casket. The terms “easel”, “plaque” and “saddle” are used herein interchangeably in describing the apparatus shown in FIGS. 38-40.

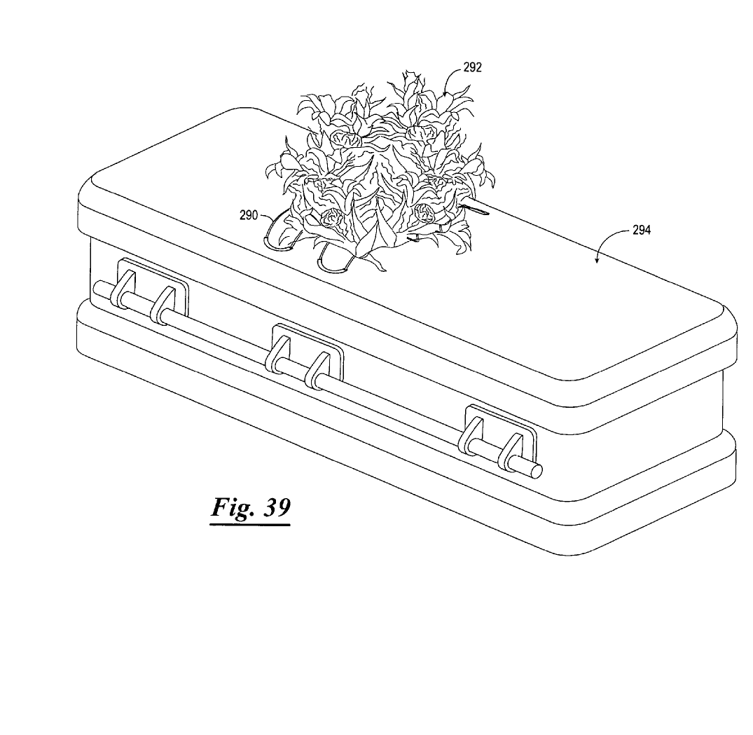

At least a portion of the floral easel or plaque 290 is constructed utilizing hollow wires of the present invention. For example, at least a portion of the floral easel or plaque 290 can be fabricated of the hollow wire 10 or any other hollow wire hereinbefore described, and if desired, at least a portion of the hollow wire can be provided with a coating, such as but not limited to the outer coatings 192, 202 or 212 of the hollow wires 190, 200 or 210, respectively. FIG. 39 depicts the use of the floral easel or plaque 290 in supporting a floral grouping 292 attached thereto on a casket 294, whereas FIG. 40 illustrates the use of the floral easel or plaque 290 in supporting the floral grouping 292 on a headstone 296.

The construction of the floral easel or plaque 290 is well known, as is the use of same to support a floral grouping on a casket and/or a stone in a cemetery. Thus, no further comments concerning the construction of the floral easel or plaque 290 or the attachment of the floral grouping 292 thereto is believed necessary for one skilled in the art to construct and employ a stone and/or casket floral easel utilizing the hollow wires of the present invention.

In addition, while one specific embodiment of a floral easel or plaque for use with caskets and/or monuments is described in illustrated herein, it is to be understood that any variations in floral easels or plaques known in the art and utilized for this same purpose also fall within the scope of the present invention when formed of hollow wire in accordance with the present invention.

Further, it is to be understood that the floral easels, plaques and/or saddles formed of hollow wire in accordance with the present invention may be utilized for any desired purpose, for example but not by way of limitation, with caskets, tombstones, headstones, stone monuments, and any other type of memorial.

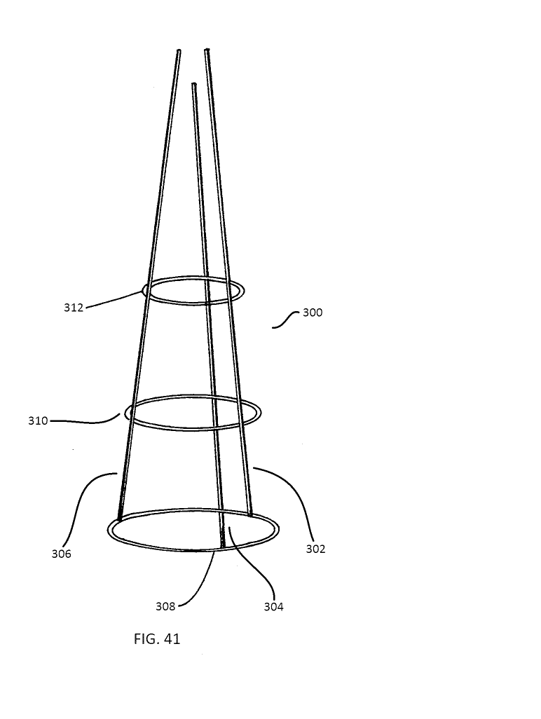

Referring now to FIG. 41, shown therein is a pictorial representation of a tomato cage 300. The tomato cage 300 may be composed of two or more vertical support members 302 and 304. Additionally, the tomato cage 300 may be composed of two or more horizontal support members 308 and 310. As shown in FIG. 41, an embodiment of tomato cage 300 may be composed of three vertical support members 302, 304, and 306 and three horizontal support members 308, 310, and 312. The vertical support members 302 and 304 may assume any floral wire form known in the art, and can be fabricated using any of the hollow wire hereinbefore described; therefore, the particular form of the vertical support members 302, 304, and 306 shown in FIG. 41 is for the purposes of illustration only. The horizontal support members 308, 310, and/or 312 may assume any floral wire form known in the art, and can be fabricated using any of the hollow wire hereinbefore described; therefore, the particular form of the horizontal support members 308, 310, and 312 shown in FIG. 41 is for the purposes of illustration only. As shown in the embodiment in FIG. 41, the horizontal support members 308, 310, and 312 may be circular in shape and attached to the vertical support members 302, 304, and/or 306 by any suitable means known in the art, for example by mechanical connection, adhesive connection, welding, or brazing. In another embodiment, the horizontal support members 308, 310, and/or 312 may be square, rectangular, triangular, pentagonal, hexagonal, octagonal, trapezoidal, oval, elliptical or any other desired shape. The horizontal support members 308, 310, and 312 may be of differing circumferences. As shown in the embodiment in FIG. 41, the horizontal support members 308, 310, and 312 have decreasing circumferences in relation to each other as they span the height of the tomato cage 300 from the bottom thereof (with horizontal support member 308 forming a bottom of the tomato cage 300 and being disposed upon a substrate), thereby creating a cone shape. As shown in the embodiment in FIG. 41, the vertical support members 302, 304, and/or 306 may be substantially straight. In another embodiment, the vertical support members 302 and 304 may contain bends to accommodate decreasing circumferences of the horizontal support members 308, 310, and 312, and containing substantially straight sections spanning between the bends accommodating the horizontal support members 308, 310, and 312.

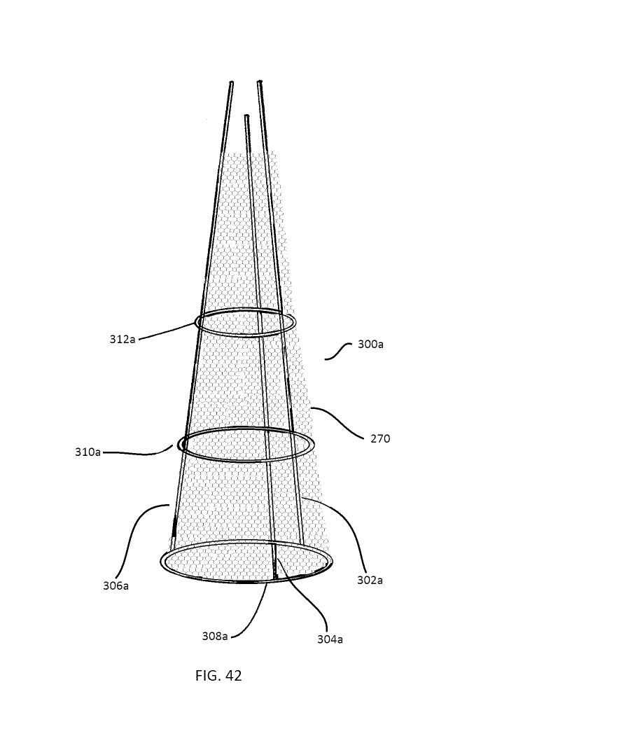

Referring now to FIG. 42, shown therein is a pictorial representation of another embodiment of a tomato cage, denoted herein by the general reference numeral 300a. The wire netting or mesh 270 shown in FIG. 36 may be employed in the construction of the tomato cage 300a shown in FIG. 42. Any of the hollow wires hereinbefore described can be employed in the construction of the wire netting or mesh 270 and therefore in the construction of tomato cage 300a. The wire netting or mesh 270 may be formed using conventional procedures well known in the art. In addition, the wire netting or mesh 270 may be used in a substantially flattened form to accommodate the square, rectangular, triangular, pentagonal, hexagonal, octagonal, or trapezoidal embodiments of the horizontal support members 308a, 310a, and/or 312a. In one embodiment, the tomato cage 300a may be constructed of wire netting or mesh 270 without the addition of one, two or all of the horizontal support members 308a, 310a, and/or 312a, and without the addition of one, two or all of the vertical support members 302a, 304a, and/or 306a. In another embodiment, the tomato cage 300a may be constructed of wire netting or mesh 270 and supported by vertical support members 302a, 304a, and 306a. In another embodiment, the tomato cage 300a may be constructed of wire netting or mesh 270 and supported by horizontal support members 308a, 310a, and 312a. In yet another embodiment, the tomato cage 300a may be constructed of wire netting or mesh 270 and supported by both vertical support members 302a, 304a, and 306a and horizontal support members 308a, 310a, and 312a.

Other uses of the hollow wire of the present invention will become apparent to persons of ordinary skill in the art of the floral industry or other industries in which wires may be used, including, but not limited to bag-closing wires, bale ties, pail handles, spiral bindings, (such as spiral bound notebooks), staples, craft and hobby wire, greening pins, staple wire, nails and the like may apply.

Changes may be made in the construction and the operation of the various components, elements and assemblies described herein or in the steps or the sequence of steps of the methods described herein without departing from the spirit and scope of the invention as defined in the following claims.

From the above description, it is clear that the present invention is well adapted to carry out the objects and to attain the advantages mentioned herein as well as those inherent in the invention. While certain embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A cage apparatus for supporting a plant, comprising:
at least two vertical support members, each of said vertical support members having a first end and a second end;
at least two horizontal support members, each of said horizontal support members being bound to each of the at least two vertical support members, where one horizontal support member is bound to the second end of each of the at least two vertical support members;
wherein at least a portion of the cage apparatus is constructed of a hollow wire, wherein the hollow wire has a sidewall having an outer surface, an inner surface, and an inner space.

2. The cage apparatus of claim 1, wherein the at least two horizontal support members are circular in shape.

3. The horizontal support members of claim 2, wherein each of the at least two horizontal support members have differing circumferences.

4. The cage apparatus of claim 1, wherein the hollow wire is further defined as having a first longitudinal edge, a second longitudinal edge, and a longitudinal groove which extends along a length of the hollow wire.

5. The cage apparatus of claim 4, wherein at least a portion of the first and second longitudinal edges of the hollow wire overlap.

6. The cage apparatus of claim 4, wherein the hollow wire has a gap between the first and second longitudinal edges.

7. The cage apparatus of claim 1, wherein the hollow wire has a polygonal cross-section.

8. The cage apparatus of claim 7, wherein the cross-section of the hollow wire is selected from the group consisting of square, rectangular, triangular, pentagonal, hexagonal, octagonal, and trapezoidal.

9. The cage apparatus of claim 1, wherein at least a portion of the hollow wire is covered with a coating, wherein the coating is selected from the group consisting of paper, plastic, fabric, ribbon, rubber, polymeric material, metal, enamel, paint, metalized fabric, metalized polymeric film, ceramic material, flocking, bonding material, and combinations thereof.

10. The cage apparatus of claim 1, wherein the hollow wire is further defined as having an outer diameter and an inner diameter.

11. The cage apparatus of claim 10, wherein the hollow wire has a circular, oval, elliptical, or parabolic cross-section.

12. The cage apparatus of claim 1, wherein the hollow wire has at least one corrugated or scored portion.

13. The cage apparatus of claim 1, wherein the hollow wire has at least one interlocking portion.

14. A cage apparatus, comprising:
a wire netting or mesh capable of being formed into a cage apparatus, wherein at least a portion of the wire netting or mesh is constructed of a hollow wire, wherein the hollow wire has a sidewall having an outer surface, an inner surface, and an inner space.

15. The cage apparatus of claim 14, wherein the hollow wire is further defined as having a first longitudinal edge, a second longitudinal edge, and a longitudinal groove which extends along a length of the hollow wire.

16. The cage apparatus of claim 15, wherein at least a portion of the first and second longitudinal edges of the hollow wire overlap.

17. The cage apparatus of claim 15, wherein at least a portion of the first and second longitudinal edges of the hollow wire abut one another.

18. The cage apparatus of claim 15, wherein the hollow wire has a gap between the first and second longitudinal edges.

19. The cage apparatus of claim 14, wherein the hollow wire has a polygonal cross-section.

20. The cage apparatus of claim 19, wherein the cross-section of the hollow wire is selected from the group consisting of square, rectangular, triangular, pentagonal, hexagonal, octagonal, and trapezoidal.

21. The cage apparatus of claim 14, wherein at least a portion of the hollow wire is covered with a coating, wherein the coating is selected from the group consisting of paper, plastic, fabric, ribbon, rubber, polymeric material, metal, enamel, paint, metalized fabric, metalized polymeric film, ceramic material, bonding material, and combinations thereof.

22. The cage apparatus of claim 14, wherein the hollow wire is further defined as having an outer diameter and an inner diameter.

23. The cage apparatus of claim 22, wherein the hollow wire has a circular, oval, elliptical, or parabolic cross-section.

24. The cage apparatus of claim 14, wherein the hollow wire has at least one corrugated or scored portion.

25. The cage apparatus of claim 14, wherein the hollow wire has at least one interlocking portion.

26. The cage apparatus of claim 14, wherein the cage apparatus further comprises at least two vertical support members, each of said vertical support members having a first end and a second end and each of said vertical support members bound to outer surface of the hollow wire of the wire netting or mesh.

27. The cage apparatus of claim 14, wherein the cage apparatus further comprises at least two horizontal support members, each of said horizontal support members being bound to the outer surface of the hollow wire of the wire netting or mesh.
